(19) United States
(12) Patent Application Publication
(10) Pub. No.: US 2003/0213175 A1
(43) Pub. Date: Nov. 20, 2003

(54) Root-ease plant transplant pot

(76) Inventors: Land Edward Rhindress, Halifax (CA); Paul M. Rhindress, Halifax (CA)

Correspondence Address: Land E. Rhindress, 38 Shrewsbury Road, Halifax, NS, B2V 1R7, CA

(21) Appl. No.: 10/145,788

(22) Filed: May 16, 2002

(51) Int. Cl. A01G 23/02

(52) U.S. Cl. 47/73

(57) ABSTRACT

A transplant pot for plants that is formed when two identical pot halves are fastened together. The invention consists of three components; the main body of the invention where parts (side walls, guide tracks, gaskets and fastening mounts) are either molded or affixed to the main body, the fastening screws and the drainage dish which is not required for structural integrity but merely for growing medium drainage. When the two halves of the invention are joined by the screws being tightened through the fastening mounts, which are molded or affixed to the side walls and threaded, the rubber compound gaskets are compressed thus creating a tight seal. When the plant requires transplantation the screws are removed from the fastening mounts to allow the pot halves to be separated. This permits the rooted plant to be removed with minimal disturbance to the plant's root system and other structures.

### BACKGROUND OF THE INVENTION

1. Field of the Invention

The invention relates to the standard planting pot which has specific utilitarian improvements over standard single piece molded pots. The primary goal of the Root-Ease transplant pot is to significantly reduce the damage to a potted plant's root system and above soil structures as it is being removed from the pot when compared to the damage caused when being removed from a standard single molded pot. The overall utility of the invention will be apparent from the following information and accompanying drawings.

2. Brief Description of the Related Art

The problem faced by inventors attempting to design transplant pots is that the invention must function as a standard single unit plant pot that makes the removal of the plant when required minimally disruptive to a plant's root system and other structures. Several attempts have been made to design starter/transplant pots. For example, U.S. Pat. No. 4,027,429, which was invented by Walter L. Georgi and filed on Mar. 11, 1976, attempted to use a disk, self watering reservoir type design. When the bottom disk was pushed up the pot's contents would be raised up and out of the pot. Though innovative, the design did not address certain problems such as ease of use, soil and contents weight restrictions during the extraction phase and the lack of control of the rate of re-absorption of water from the reservoir that would affect certain plants requiring very restricted amounts of water, such as cacti. U.S. Pat. No. 5,157,869, which was invented by James D. Minton and filed on Nov. 29, 1990, also a very innovative invention; however does not lend its design to pots of increasing size nor to ease of use during transplantation of the plant. It would appear from the inventions description that the compression action required for disassembly of the pot would cause the very damage to the plant's root system that was to be avoided.

The present invention, due to its external fastening mounts and ease of assembly and disassembly provides a very effective transplant system. The plant and soil do not need to be manipulated during the opening of the inventions two sides and little to no handling of the plant is required when transplanting the plant from the invention to its new growing environment.

### SUMMARY OF THE INVENTION

The present invention resulted from the current lack of availability in the retail market of transplant pots that function as adequately as the invention presented in this document. During the prototype development and testing phase not only was design functionality and ease of use taken into consideration but also simplicity of manufacture. During the testing phase of the invention it not only met but exceeded the design expectations. Specifically, not only did the gasket system retain moist soil and plant material, the invention was also able to act as a beaker. When filled completely with water no leakage took place, when the bottom drainage holes were plugged. The testing phase demonstrated the integrity of the Root-Ease transplant pot's design. The following description will detail the parts of the Root-Ease transplant pot and specify how these parts interact to form the present invention.

### BRIEF DESCRIPTION OF THE DRAWINGS

FIG. 1 is an exploded longitudinal view of the invention.

FIG. 2 is a longitudinal view of the assembled invention.

FIG. 3 is a magnified aerial view of the guide track and gasket design. FIG. 3 illustrates how the pot walls are guided by the guide tracks.

FIG. 4 illustrates the gaskets being compressed when the invention is assembled.

FIG. 5 is an aerial view of the assembled invention.

FIG. 6 is a longitudinal cross-sectional view of the invention. FIG. 6 illustrates how the gaskets and guide tracks as well as the raised mounts are designed.

### DETAILED DESCRIPTION OF THE INVENTION

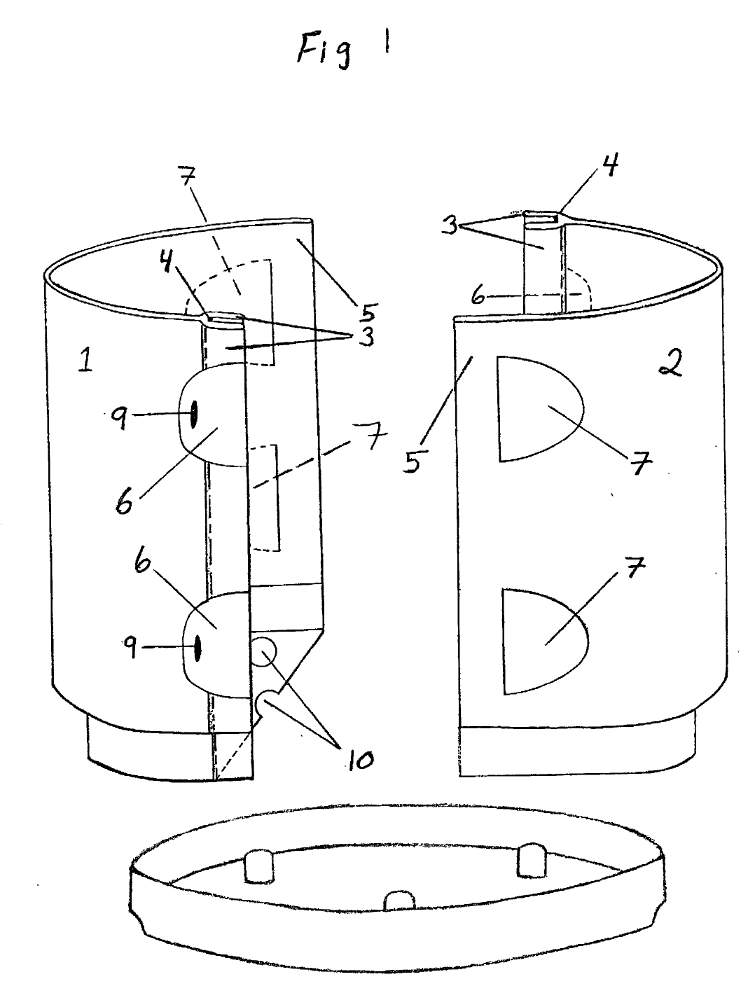

In order to succinctly explain the present invention, the accompanying figures will be described. FIG. 1, is an exploded longitudinal portrait of the invention. Part 1, is identical to part 2. This design facilitates ease of manufacture. The circumference of the joined identical cylindrical halves (part 1 and 2) of the pot, minus the width of the compressed gasket (4) when the halves are mated to each other and the compressed gasket will form a 360-degree cylindrical design thus ensuring the invention a circular form. To further elaborate, if the halves 1 and 2 were not reduced by the width of the compressed gaskets a bulge would form which would distort the 360-degree circular form of the invention.

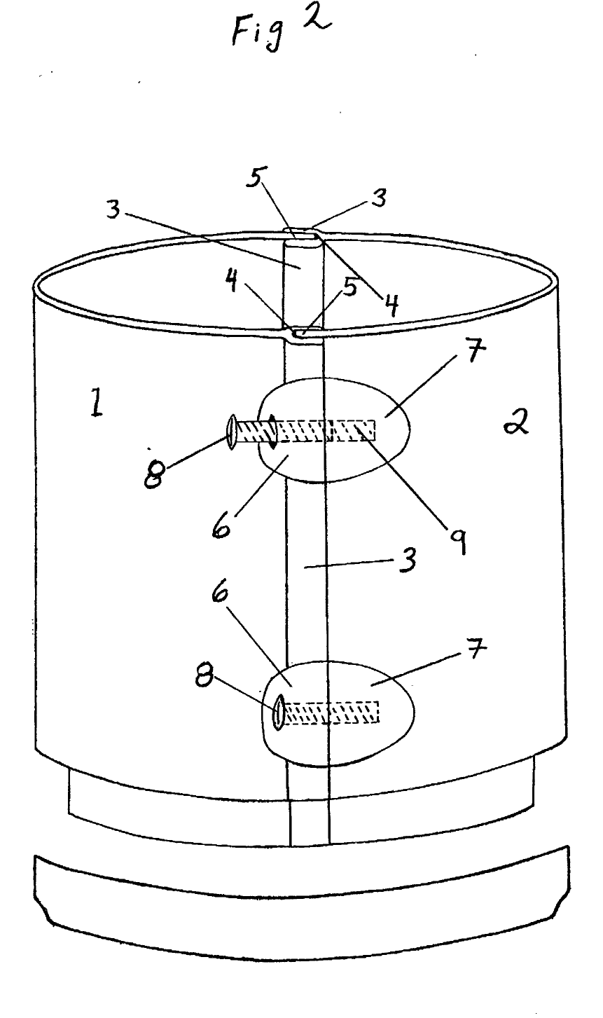

Parts 1 and 2 will be joined together by inserting side walls (5) into guide tracks (3). When the side walls (5) have been inserted into guide tracks (3), against the rubber compound gaskets (4), fastening devices (8—FIG. 2) will be inserted and screwed into grooved threaded holes (9) located in the raised mounts (6 and 7). Once parts 1 and 2 are aligned the raised mounts (6 and 7) will be secured together. Refer to FIG. 2 to view the present invention assembled. Upper part 8 is protruding showing the design.

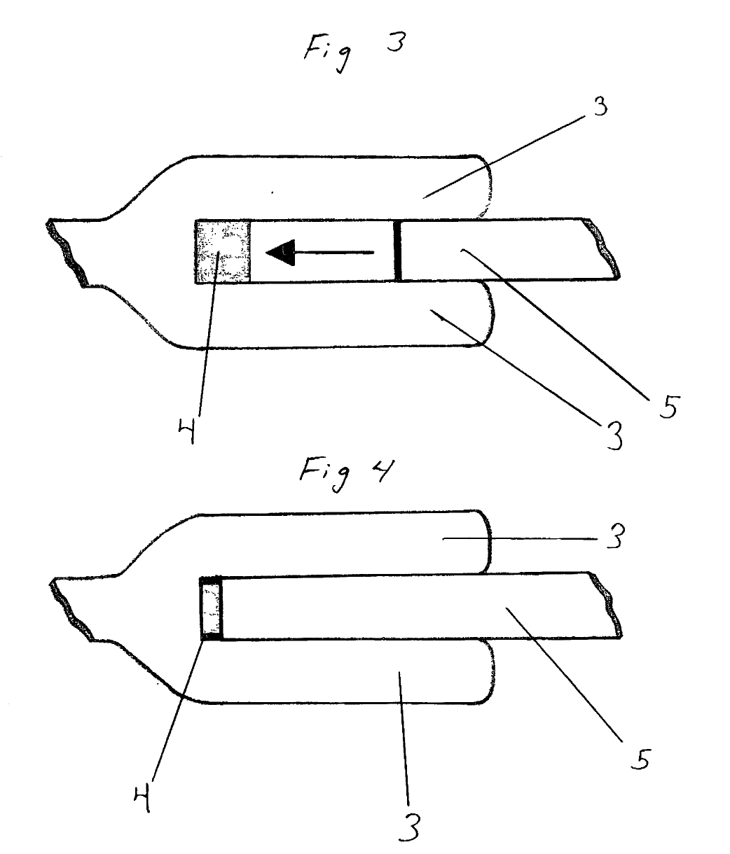

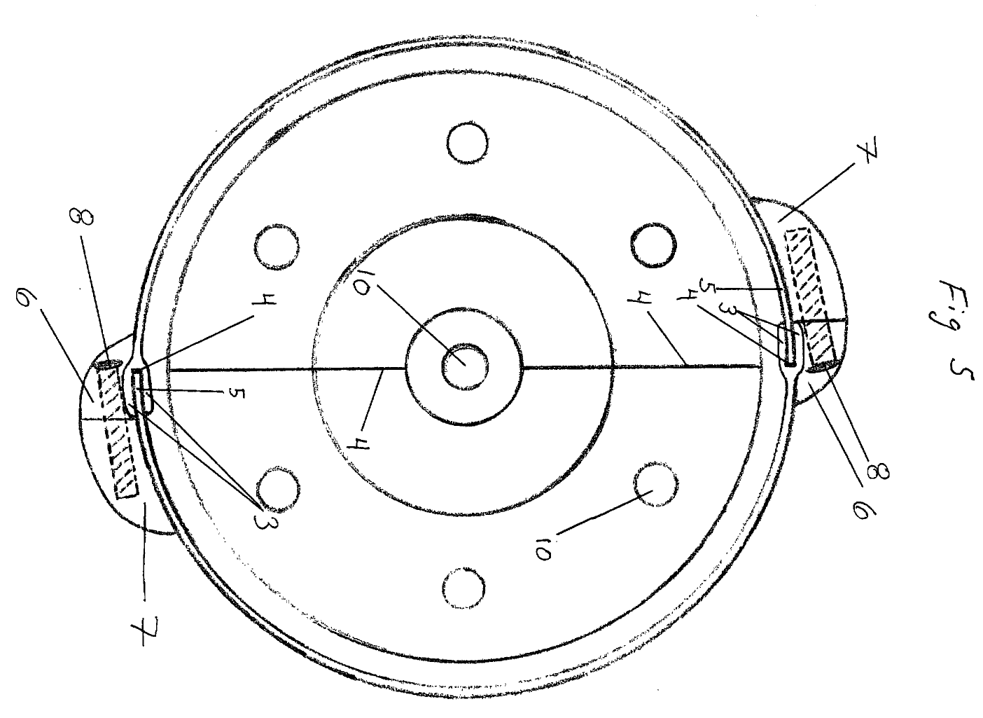

When the invention is assembled upper part 8 will be secured as is lower part 8. FIGS. 3 and 4 are enlarged aerial views of parts 3, 4 and 5 consisting of the guide tracks (3), rubber compound gaskets (4) and the side walls (5). FIGS. 3 and 4 illustrate how the guide tracks (3) act in providing a guide for the side walls (5). The gasket (4) is shown in FIG. 4 as being compressed after pot halves (1 and 2) have been secured by the fastening devices (8) and raised mounts (6 and 7). This gasket and guide track design (FIGS. 3 and 4) provides a watertight seal; minus the drainage holes (10).

The invention is now a self-supporting, stand-alone plant pot. As is standard with many plant pots a snap on soil drainage dish is attached to the bottom of the present invention. The drainage dish is affixed by three pegs, which are molded into the dish. Inserting the three pegs into three of the outer six holes (10) will fasten the dish to the bottom of the assembled invention. The drainage dish has no bearing on the inventions structural integrity when assembled and thus is not presented as part of the patent.

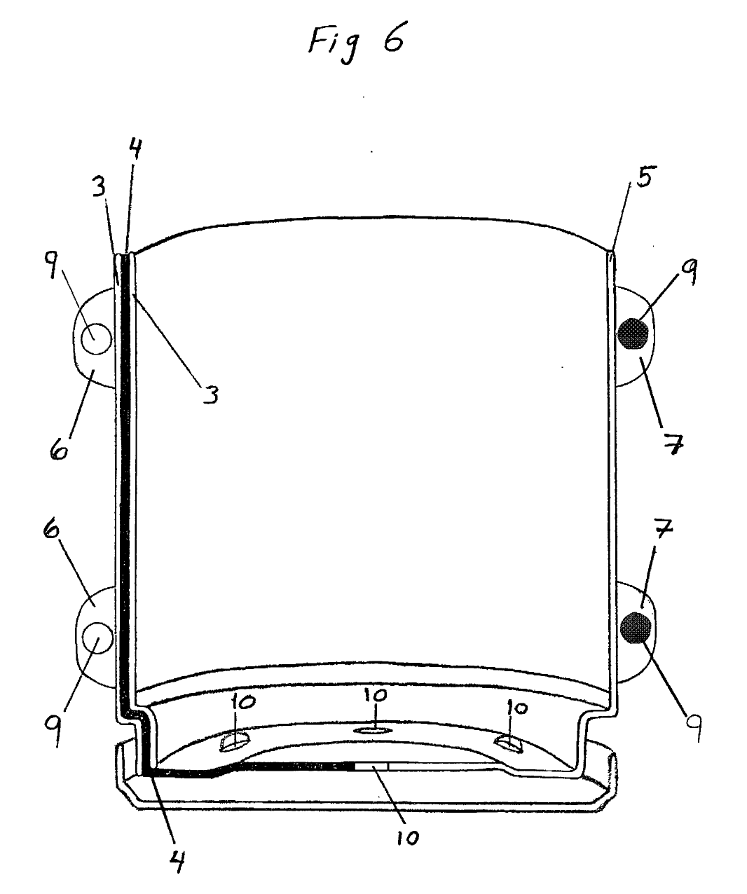

The assembled pot is now ready to receive growing medium and plant material. FIG. 6 is a longitudinal view of part 1 or 2. This once again, illustrates the identical design of both parts 1 and 2 with resulting ease of manufacture. When removal (transplantation) of the pots contents is desired, unscrew and remove the fastening mechanisms (8) from the raised fastening mounts (6 and 7). Tilt the pot to one side. Gently separate sides 1 and 2. The contents are now cradled in the selected side of the pot. The process of transplantation from this point would be dictated by the type of plant. Little to no handling of the plant is required during the transplantation phase.

What is claimed:

1. A transplant pot for plants being comprised of two identical halves that when connected form a sealed pot, minus the drainage holes, the invention acts as a single unit pot during plant growth but separates with ease for plant transplantation.

2. A transplant pot for plants made up of two identical halves, each containing a U-shaped guide track that is molded as part of the invention along one-half of each part of the main body; these guide tracks have a rubber compound gasket, or comparable compound, that has been affixed to the lower portions of the U-shaped guide tracks of which the guide tracks become the receiving side or female part and the opposing side of each half of the invention lacking the guide track and gasket being the male part that can be inserted in the receiving U-shaped guide track.

3. A transplant pot for plants that is constructed of two identical joined halves that significantly reduces the plant shock and damage to a potted plant's root system and above soil structures when they are being removed from the pot as compared to the plant shock and damage caused while being removed from a standard single molded pot.

4. A transplant pot for plants that is a sealed unit when assembled, minus the drainage holes, that due to fastening mounts on each side of the inventions halves and the screwing mechanisms that when the screwing mechanisms are tightened the invention halves seal along its walls where the halves meet due to the rubber compound gaskets, or comparable compound, that lay in the U-shaped guide tracks being compressed to provide the seal.

5. A transplant pot for plants which is structurally sound and requires no additional support attachments that can be manufactured by injection plastic molding but also lends itself to being constructed of various materials such as clay, wood and metal.

6. A transplant pot for plants, the design of which can be applied to pots of increasing size.

7. A transplant pot for plants that is both functional and novel.
